(19) United States
(12) Patent Application Publication
(10) Pub. No.: US 2025/0224109 A1
(43) Pub. Date: Jul. 10, 2025

(54) Illuminated floor and method for producing an illuminated floor

(71) Applicant: Denis BRONSERT, Plauen (DE)

(72) Inventor: Denis BRONSERT, Plauen (DE)

(21) Appl. No.: 18/853,802

(22) PCT Filed: Feb. 3, 2023
(86) PCT No.: PCT/DE2023/000009

§ 371 Date: Oct. 3, 2024

(30) Foreign Application Priority Data
Feb. 16, 2022 (DE) 10 2022 000 580.8

(51) Int. Cl. F21V 33/00; E04F 15/12; F21V 23/02; F21Y 113/00; F21Y 115/10

(52) U.S. Cl. CPC F21V 33/006; E04F 15/126; F21V 23/023; F21Y 2113/00; F21Y 2115/10

(57) ABSTRACT

Illuminated flooring for the interior and exterior of buildings, includes a load-bearing substructure having a composite screed layer and lighting fixtures. A channel system with light output units (2) is arranged on the load-bearing substructure (9) and the channel system and the light output units (2) are embedded in a casting layer structure and ribbon cables with LEDs mounted thereon in sections are inserted into the channel system.

### CROSS-REFERENCE TO RELATED APPLICATION

This application is a national stage application, filed under 35 U.S.C. § 371, of International Patent Application PCT/DE2023/000009, filed on Feb. 3, 2023, which claims the benefit of German Patent Application DE 10 2022 000 580.8, filed on Feb. 16, 2022.

### TECHNICAL FIELD

The disclosure relates to illuminated flooring and to a method for producing illuminated flooring that can be walked or driven on and is for the interior and exterior of buildings, wherein the upper side of the light output units is substantially flush with a cover layer.

### BACKGROUND

In lighting technology, it is often necessary to illuminate relatively large areas, such as floors, for example. For this purpose, it is known, for example, to use spotlight lighting devices spaced apart from one another. For example, a flooring light is known from EP 1 805 454 B1, wherein the flooring light and the cabling required to supply it with electricity are installed into the asphalt surface of a road.

A floor light having a light unit and a support unit, which can be mounted in a superstructure of a floor that can be walked and/or driven on and which supports the light unit, is known from DE 20 2010 012 662 U1, wherein the light unit radiates light on its upper side, wherein the upper side of the light unit ends substantially flush with the upper side of the support unit and with the surface of the superstructure. The invention further relates to a floor that can be walked or driven on. For producing the floor, initially the floor light can be placed on a substructure and subsequently be overmoulded with mastic asphalt in a desired manner.

A floor light for surfaces that can be walked and/or driven on is previously known from DE 201 02 832 U1. The floor light has a cover consisting of thermally tempered glass. A light guide plate which is lit by light-emitting diodes is arranged therebelow. The cover consists of tempered safety glass. Together with light source supports and diffusion and/or light guide devices, it is accommodated in an upper light source housing, which is placed removably on a lower base housing that is fixedly installed in the floor and in which the electrical supply devices are accommodated.

A lighting system consisting of cover panels and light fixtures is described in DE 20 2005 013 299 U1. Applications of the innovation are in the field of functionalization of wall or floor coverings and for producing surfaces having one or more light sources, in particular with an astatic and/or informative nature. In this case, a circuit board which carries at least one light fixture is fixed on the covering panel, in particular tiling or floor panels.

DE 101 43 789 A1 discloses an LED floor light. This floor light consists of a transparent circuit board which is fitted with a desired number of LEDs. This circuit board is encapsulated with synthetic resin, with a choice of shape and size. This creates a very thin, watertight floor light that can be walked on. In another light, for creating light effects and achieving uniform luminance over the entire light surface, the circuit board having the light sources is cast facing downwards against a reflective surface and discs of decorative, translucent materials are cast, glued or clamped onto it.

Floor or wall tiles, for example consisting of ceramic, are known from WO 01/71122, in which inlays which are illuminated by optical waveguides are disclosed. The inlay consists of a transparent material or a diffusely reflecting fibre optic element. The inlay is connected via an optical waveguide to a light source which is at a distance. These tiles enable different lighting effects to be implemented, though special handling is required when installing the tiles. Also, at the place at which the tiles are used according to WO 01/71122, the installation and maintenance of a light source located at a distance from the tiles has to be given particular attention.

DE 20 2010 007 325 U1 relates to a floor light having a light unit and a support unit, which can be mounted in a superstructure of a floor that can be walked and/or driven on and which supports the light unit, wherein the light unit radiates light on its upper side, wherein the upper side of the light unit ends substantially flush with the upper side of the support unit and with the surface of the superstructure. The invention further relates to a floor that can be walked or driven on.

EP 1 805 454 B1 describes an LED-based lighting device for mounting on ground, wall, floor or road surfaces, which provides a light fixture, which provides, on the surface in the area intended to remain visible, one or more optical diffusing devices which are arranged on LED-based light sources, wherein the latter together with associated control systems are inserted into an encapsulation housing which contains a filling material in order to create a peripheral optical signalling system for road surfaces, gardens and car parks. The LED-based light sources together with the associated control systems are coated with an elastomeric material and the light fixture is provided on the surface with open cavities for inserting the hook-shaped ends of a tool, which is able to facilitate the attachment and removal of the light fixture into or from a corresponding housing.

### SUMMARY

The present application provides lighting that can be installed permanently in a floor that can be walked and/or driven on, in the form of an aesthetic and/or informal design, which is as stable and thus resistant against vandalism as possible, and which can simultaneously be maintained with low effort (e.g. by changing the lighting unit).

This is achieved with an illuminated flooring as disclosed herein, and with a method for producing an illuminated flooring that can be walked or driven on and is for the interior and exterior of buildings as disclosed herein.

The illuminated flooring comprises a load-bearing substructure having a separating layer on which a channel system with light output units is arranged, and the channel system and the light output units are embedded in an encapsulating layer structure and ribbon cables with LEDs mounted thereon at intervals are inserted into the channel system. The channel system and the light output units consist of a translucent plastic material and are preferably produced by means of a 3D-printing method or in the injection molding process.

The channel system can be in the formed of a strip or grid and is constructed as a plug-in system. The plug-in system comprises channel sections having at least one light output unit, intermediate pieces, connecting pieces, closure pieces and end pieces for a strip-shaped structure. For the grid-shaped structure, grid sections rather than channel sections are used.

An end piece having a section bent upwards is plugged onto one end of the channel system. This serves to introduce a strip-shaped guide fitted with LEDs. A closure piece is placed onto the opposite side of the channel system, thereby preventing the flowing screed from penetrating into the channel system.

The light output units have light-conducting crowns which are formed in the shape of regular and/or irregular prismatic bodies. The light that originates from the LEDs provided below the light output units in the channel system is guided into the light-conducting crowns.

According to the specified pattern for lighting the flooring, the channel system having the light output units is applied to a load-bearing substructure, for example a raw concrete slab, which is provided with a levelling layer (bonded screed). Slippage can be prevented, for example, by applying adhesive.

After applying the channel system with the light output units, a first layer, preferably consisting of flowing screed, is applied. This is level with the lower edge of the light-conducting crowns. After the hardening and drying of the flowing screed layer, the cover layer is then applied. The cover layer can be formed from filling compounds or also from a terrazzo layer.

After the hardening and drying of the cover layer, any protruding areas of the end pieces can be separated off and the flooring surface can be sanded and sealed.

Subsequently, the ribbon cables with the LEDs mounted thereon at intervals are inserted via the end pieces into the cable system. This can also take place without using tools depending on the corresponding stiffness of the ribbon cables.

The electrical connection of the ribbon cables to the LEDs mounted thereon at intervals takes place by cables using a corresponding control and power supply unit. This can preferably be accommodated in a two-part hollow wall junction box.

The openings of the end pieces and the electric cables can be covered or accommodated by a skirting board. Alternatively, the electric cables can be laid under plaster.

Applications of the invention are in the field of functionalization of flooring surfaces inside and outside in the form of aesthetic and informative lighting design. Examples of the use of the invention are in dry and wet areas. For example, for flooring in living areas, such as bathrooms, saunas and fitness rooms, for example in public buildings, such as entrances and halls in offices, entrances and event areas in hotels, cinemas or in swimming pools, in wellness and sports facilities, for example in outdoor areas such as on balconies and verandas.

The advantage of the system according to the disclosure is that discrete lighting can be created by the use of light-conducting crowns at intervals in the flooring surface, wherein the light-conducting crowns can assume any regular and/or irregular shape. A further advantage is that the light-conducting crowns can be formed as illuminated information signs, for example arrows, and thus can mark emergency exits in rooms, hallways or corridors.

### BRIEF DESCRIPTION OF THE DRAWINGS

The invention is to be explained in more detail using an exemplary embodiment.

FIG. 1 shows a channel section.

FIG. 2 shows an intermediate piece.

FIG. 3 shows a connecting piece.

FIG. 4a shows an end piece.

FIG. 4b shows a closure piece.

FIG. 5 shows a channel grid.

FIG. 6 shows a flooring structure.

FIG. 7 shows a section of an illuminated floor surface.

### DETAILED DESCRIPTION

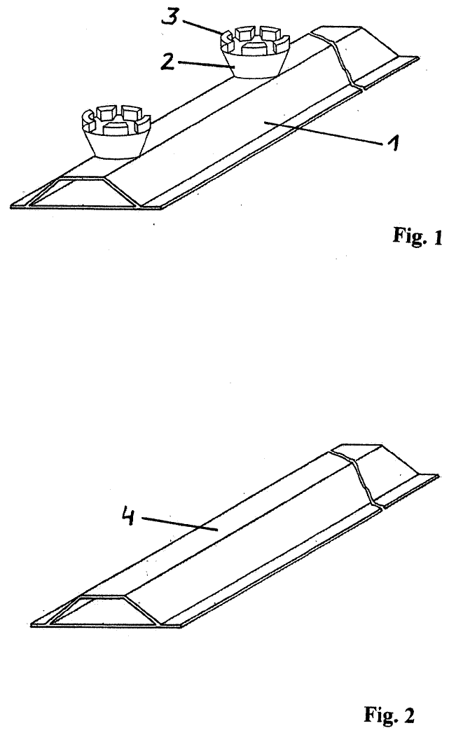

FIG. 1 shows a channel section 1 having mounted light output units 2. Both the channel sections 1 and light output units 2 are produced from a translucent plastic in the 3D-printing method.

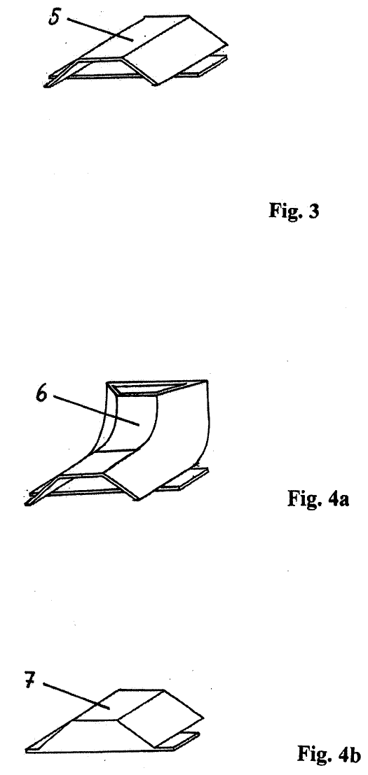

FIGS. 2, 3, 4a, and 4b show further individual parts, from which linear cable channel systems for illuminating floor surfaces can be composed in connection with the channel sections 1. The individual parts comprise the connecting pieces 5, the intermediate pieces 4, the end pieces 6 and the closure pieces 7.

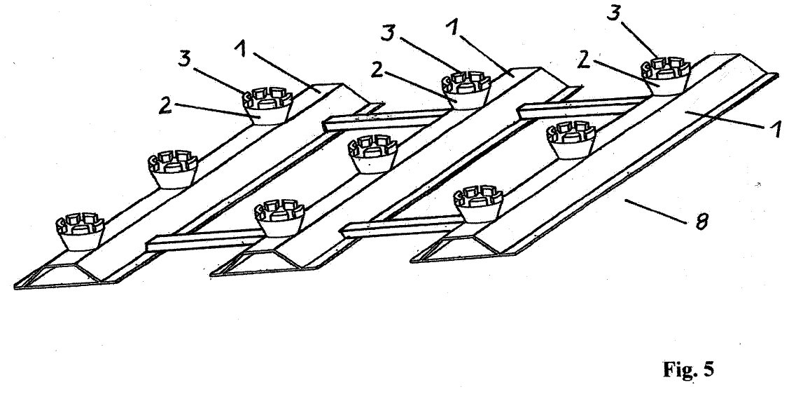

FIG. 5 shows a channel grid 8 that consists of three channels which are connected to one another by bridges. In connection with the individual parts, connecting pieces 5, intermediate pieces 4, end pieces 6 and closure pieces 7, an extensive channel system can be formed.

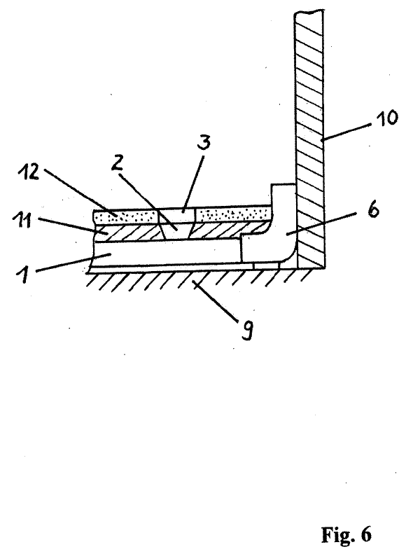

FIG. 6 shows an excerpt of the structure of an illuminated flooring. A channel system, comprising a channel section 1 having a light output unit 2 and an end piece 6 placed on the wall 10, is applied onto a load-bearing substructure 9 with a bonded screed layer, and if necessary is secured against slipping by adhesive bonding.

Subsequently, the channel system is embedded with the aid of a flowing screed layer 11. The flowing screed layer 11 is applied up to the lower edge of the light-conducting crowns 3.

After the hardening and drying of the flowing screed layer 11, a cover layer 12 is applied as another layer up to the upper edge of the light-conducting crowns 3.

After the hardening and drying of the cover layer 12, the surface is sanded and sealed. Subsequently, the light fixtures which are mounted on a ribbon cable in the form of LEDs are inserted, and the electrical connection to a control and power supply unit is made. The ribbon cables having the applied LEDs are formed in such a way that the LEDs each come to rest at the point at which a light output unit is located on the channel section 1 or on the channel grid 8.

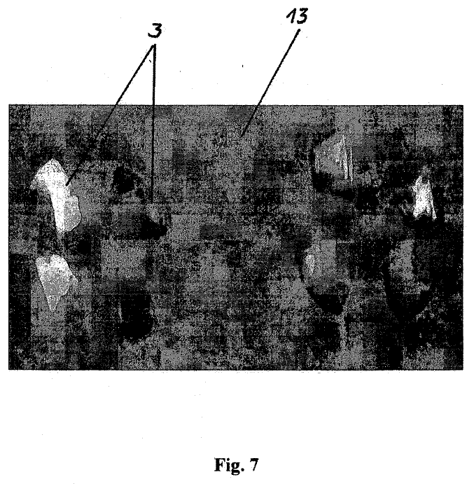

FIG. 7 shows a section of an illuminated floor surface 13 having the corresponding light-emitting surfaces of the light-conducting crowns 3.

### REFERENCE NUMERAL LIST

1 channel section
2 light output unit
3 light-conducting crown
4 intermediate piece
5 connecting piece
6 end piece
7 closure piece
8 channel grid
9 substructure
10 wall
11 flowing screed layer
12 cover layer
13 floor surface

1.-7. (canceled)

8. An illuminated flooring, comprising:
a load-bearing substructure with a bonded screed layer and lighting fixtures; and
a channel system with light output units (2) arranged on the load-bearing substructure (9),
wherein the channel system and the light output units (2) are embedded in an encapsulating layer structure, and
wherein ribbon cables with LEDs mounted thereon at intervals are inserted into the channel system.

9. The illuminated flooring according to claim 8,
wherein the light output units (2) and the channel system consist of a translucent plastic material.

10. The illuminated flooring according to claim 8,
wherein the channel system is constructed in strip form from at least one channel section (1) having at least one of the light output units (2), at least one intermediate piece (4), connecting pieces (5), a closure piece (7), and an end piece (6).

11. The illuminated flooring according to claim 8,
wherein the channel system is formed from at least one channel grid (8) having one or more of the light output units (2), intermediate pieces (4), connecting pieces (5), end pieces (6), and closure pieces (7).

12. The illuminated flooring according to claim 8,
wherein the light output units (2) have light-conducting crowns (3), and
wherein the light-conducting crowns (3) are formed in shape of regular and/or irregular prismatic bodies.

13. The illuminated flooring according to claim 8,
wherein a casting layer is applied after laying the channel system onto the load-bearing substructure (9),
wherein the structure consists of a flowing screed layer and a cover layer.

14. A method for producing an illuminated flooring, comprising:
applying, in a first step, a channel system having light output units (2) onto a load-bearing substructure (9) having a composite screed layer in accordance with an installation plan;
applying, in a second step, a flowing screed layer (11) up to a lower edge of light-conducting crowns (3);
applying, in a third step, after hardening and drying of the flowing screed layer (11), a cover layer (12) up to an upper edge of the light-conducting crowns (3);
separating, in a fourth step, after hardening and drying of the cover layer (12), protruding regions of end pieces (6) and sanding and sealing a surface; and
inserting, in a fifth step, ribbon cables having LEDs mounted thereon at intervals into the channel system and connecting the ribbon cables to a control unit and a power supply unit.
